(19) United States
(12) Patent Application Publication
(10) Pub. No.: US 2006/0059042 A1
(43) Pub. Date: Mar. 16, 2006

(54) System for rotation of software advertisements

(76) Inventor: Meir Zohar, Givat Shmuel (IL)

Correspondence Address: DANIEL J SWIRSKY, 55 REUVEN ST., BEIT SHEMESH, 99544, IL

(21) Appl. No.: 10/938,751

(22) Filed: Sep. 13, 2004

(51) Int. Cl. G06Q 30/00

(52) U.S. Cl. 705/14

(57) ABSTRACT

An advertising system including an application for execution by a client, a promoter, an advertising server, and a displayer, where the application is operative to communicate to the promoter information relating to either of the life cycle and the current status of either of the application and the client, where the promoter is operative to communicate a request for instructions to the advertising server, where the advertising server is operative to construct and transmit to the promoter a set of instructions for the promoter indicating at least one advertisement of relevance to the client based on a predefined relevance measure of the information, and where the promoter is operative to retrieve the advertisement indicated in the instructions and provide the advertisement for rendering by the displayer at the client.

### FIELD OF THE INVENTION

The present invention relates to software-based advertising in general, and more particularly to the periodic rotation of advertisements.

### BACKGROUND OF THE INVENTION

In advertising, an advertiser may employ a promoter to provide the medium by which the advertiser gains access to an audience and is able to display his product, such as merchandise or services, to the audience. Typically, the promoter is paid for his service in one of two ways: either the promoter receives a flat fee for the distribution of an amount of advertising material, or the promoter is paid based on the success of the advertising campaign.

The success of the promoter is dependant on the promoter's ability to maximize the distribution of the appropriate advertisements as a function of his financial reward. Unfortunately, the promoter cannot always control the method of exhibition of an advertisement or the audience's response to the advertisement.

### SUMMARY OF THE INVENTION

In one aspect of the present invention an advertising system is provided including an application for execution by a client, a promoter, an advertising server, and a displayer, where the application is operative to communicate to the promoter information relating to either of the life cycle and the current status of either of the application and the client, where the promoter is operative to communicate a request for instructions to the advertising server, where the advertising server is operative to construct and transmit to the promoter a set of instructions for the promoter indicating at least one advertisement of relevance to the client based on a predefined relevance measure of the information, and where the promoter is operative to retrieve the advertisement indicated in the instructions and provide the advertisement for rendering by the displayer at the client.

In another aspect of the present invention the request includes any of the information.

In another aspect of the present invention further includes an advertising database operative to store meta-information related to the advertisement.

In another aspect of the present invention the meta-information includes a categorization of the advertisement.

In another aspect of the present invention the indication of the advertisement includes a link to the advertisement on a creative server.

In another aspect of the present invention the displayer is operative to activate a window on the client in which the advertisement may be viewed.

In another aspect of the present invention the displayer is operative to activate the window when the application is active on the client, and either hide or deactivate the window when the application is no longer active on the client.

In another aspect of the present invention the displayer is operative to notify the promoter upon the successful rendering of the advertisement.

In another aspect of the present invention the displayer is operative to notify the promoter of any user interaction with the advertisement.

In another aspect of the present invention the promoter is operative to provide display statistics for the advertisement to the advertising server.

In another aspect of the present invention a method is provided for rotation of advertisements, the method including assembling a first plurality of advertisements, instructing a displayer to rotatingly display the first plurality of advertisements, recording an actual viewing time for the first plurality of advertisements, comparing the actual viewing time with a predicted viewing time of the first plurality of advertisements, assembling a second plurality of advertisements as a function of the comparison.

In another aspect of the present invention a method is provided for managing advertisements, the method including detecting a usage pattern of a client, and assembling a plurality of advertisements for display at the client as a function of the usage pattern.

In another aspect of the present invention a method is provided for managing advertisements, the method including monitoring the display of a plurality of advertisements at a client, comparing the actual viewing time of the plurality of advertisements with an expected viewing time of the plurality of advertisements, and adjusting the desired viewing time of any of the plurality of advertisements as a predetermined function of the comparison.

In another aspect of the present invention a method is provided for managing advertisements as a function of profit, the method including maintaining an association between client behavior regarding an advertisement and an expected profit for a promoter from an owner of the advertisement, monitoring the behavior of a client, and modifying the allotted viewing time of an advertisement at the client in accordance with a predefined function of the behavior in order to maximize the expected profit.

In another aspect of the present invention a method is provided for server-side profit optimization, the method including organizing a plurality of advertisements into at least two groups, distributing each of the groups of advertisements to each of a plurality of different population segments, monitoring a client usage pattern with respect to any of the advertisements in any of the groups, and providing advertisements from any two of the groups to a client together with a total display time adapted in accordance with a predefined function of the client usage pattern.

In another aspect of the present invention the method further includes reducing the display time of any of the advertisements provided to the client and belonging to one of the groups, and increasing the display time of any others of the advertisements provided to the client and belonging to another of the groups, where the increasing and reducing steps are performed as a function of the client usage pattern indicating a lower likelihood of client interaction with advertisements in the reduced display time group and a greater likelihood of client interaction with advertisements in the increased display time group and where the total display time is preserved.

It is appreciated throughout the specification and claims that the term “advertisement” may refer to any form of communication between an advertiser and an audience, such as an audio and/or visual presentation, and that the “viewing,” “showing,” or “displaying” of an advertisement may refer to audio and/or visual rendering of an advertisement.

### BRIEF DESCRIPTION OF THE DRAWINGS

The present invention will be understood and appreciated more fully from the following detailed description taken in conjunction with the appended drawings in which:

FIG. 1 is a simplified pictorial illustration of an advertising system, constructed and operative in accordance with a preferred embodiment of the present invention;

FIG. 2 is a simplified flowchart illustration of a method for rotating advertisements, operative in accordance with a preferred embodiment of the present invention;

FIG. 3 is a simplified flowchart illustration of a method for setting the viewing time of advertisements, operative in accordance with a preferred embodiment of the present invention;

FIG. 4 is a simplified flowchart illustration of a method for rotation of advertisements as a function of profit, operative in accordance with a preferred embodiment of the present invention; and

FIG. 5 is a simplified flowchart illustration of a method for server-side profit optimization, operative in accordance with a preferred embodiment of the present invention.

### DETAILED DESCRIPTION OF PREFERRED EMBODIMENTS

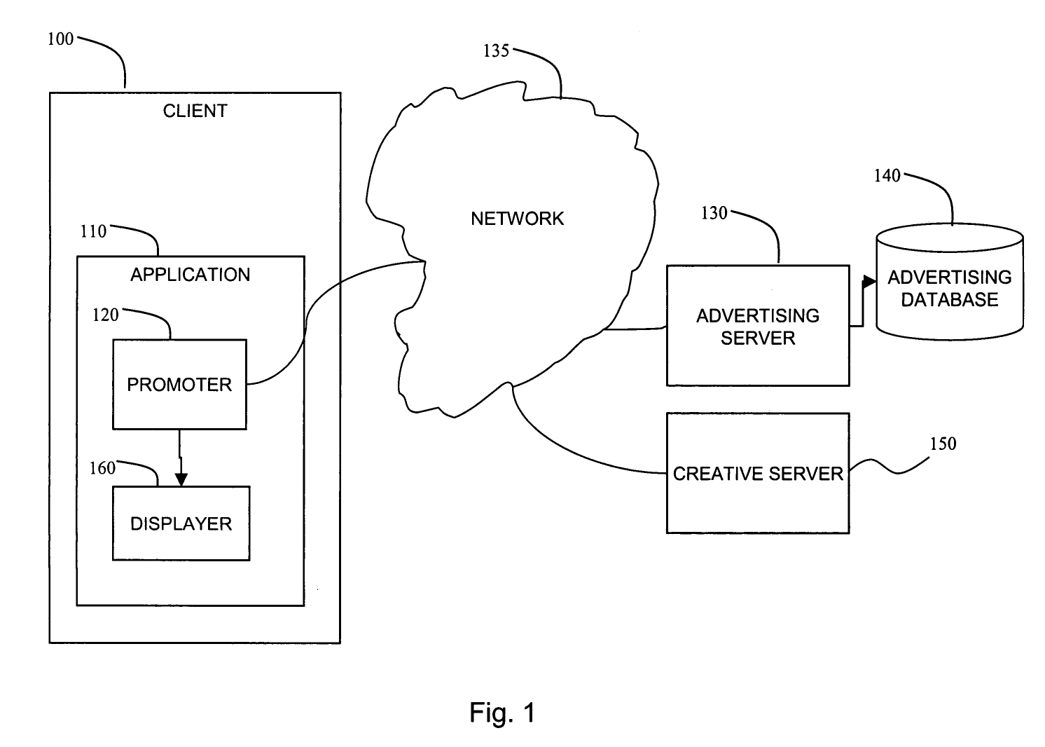

Reference is now made to FIG. 1, which is a simplified pictorial illustration of an advertising system, constructed and operative in accordance with a preferred embodiment of the present invention. In FIG. 1 a client 100, such as a personal computer, may execute an application 110, such as a word processor, that preferably incorporates a promoter 120. Application 110 may communicate to promoter 120 over an application programming interface (API) information relating to its life cycle, such as via a function called on initiation of application 110, as well as other forms of information, such as those relating to the current status of the application 110 or client 100, such as a function called notifying promoter 120 when application 110 is visible on client 100. Promoter 120 is preferably capable of creating a communication channel to an advertising server 130 over a network 132, such as the Internet. Promoter 120 preferably transmits to advertising server 130 a request for instructions, such as a request for advertisements relevant to client 100 using any known relevance measure. Furthermore, the request may include the information communicated by application 110, or information derived therefrom. For example, application 110 may communicate to promoter 120 its application type, e.g., an office application.

Advertising server 130 preferably employs an advertising database 140 to store advertising meta-information, such as the categorizations of particular advertisements in advertising campaigns. For example, an advertising campaign for women's shoes may fall under the general category of ‘apparel’ and may also appear in the category of ‘women’. The information communicated by promoter 120 may indicate to advertising server 130 which types of advertisements stored in advertising database 140 are relevant to client 100. For example, promoter 120 may communicate a request for an advertisement for women shoes to advertising server 130, which may indicate to advertising server 130 that any advertisement for women's apparel is suitable. Advertising server 130 preferably constructs a set of instructions for promoter 120, such as links to advertisements on a creative server 150 and the amount of time to display each advertisement, that is sent to promoter 120 to satisfy the request sent by promoter 120 and that may be based on the information provided by promoter 120.

Promoter 120 preferably attempts to follow the instructions received from advertising server 130 and retrieves advertisements indicated in the instructions from creative server 150. Promoter 120 preferably transmits the retrieved advertisements and their related instructions to a displayer 160, such as a computer monitor or any known output device, for audio and/or visual rendering. Displayer 160 may activate a window on client 100 in which an advertisement may be viewed, such as when application 110 is active on client 100, and may hide or deactivate the window, such as when application 110 is no longer active on client 100. Displayer 160 preferably notifies promoter 120 upon the successful rendering of an advertisement and any subsequent user interaction with the advertisement, such as a mouse click, enabling promoter 120 to track the display and user interaction statistics of each advertisement.

Promoter 120 preferably maintains the communication channel with advertising server 130 through which promoter 120 may transmit information to advertising server 130, such as display statistics indicating, for example, how often an advertisement has been shown by client 100, and through which advertising server 130 may transmit information to promoter 120, such as the cancellation of an advertisement.

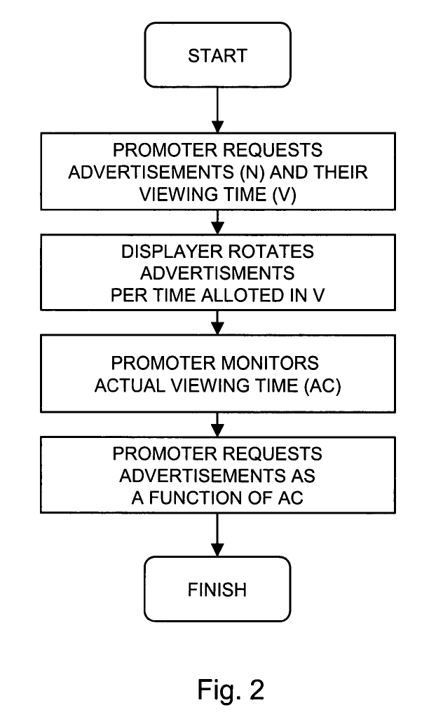

Reference is now made to FIG. 2, which is a simplified flowchart illustration of a method for rotation of advertisements, operative in accordance with a preferred embodiment of the present invention. The method of FIG. 2 may be implemented by promoter 120 in conjunction with displayer 160 and advertising server 130 of FIG. 1. In the method of FIG. 2, at any given moment advertising server 130 typically maintains references to a finite number of advertisements, denoted as N, that are relevant to client 100, and a viewing time, denoted Vᵢ, for each advertisement i. In the method of FIG. 2 promoter 120 preferably requests from advertising server 130 the maximum number of advertisements from among the N advertisements that have been allotted for a given time period, such as for a particular day, and the viewing time per advertisement, Vᵢ. The average viewing time typically allotted per advertisement on client 100, AV, may be calculated by promoter 120 by averaging the elements in V, e.g.

$$AV = \frac{1}{N} {\sum }_{N}^{i = 1} Vi .$$

Promoter 120 preferably instructs displayer 160 to rotate the advertisements such that each advertisement is displayed once for its allotted time Vᵢ.

Subsequently, promoter 120 preferably monitors the behavior of client 100, such as by monitoring the visibility of displayer 160, and records the amount of actual viewing time of all advertisements for the day, denoted AC. During a subsequent time period, such as throughout the next day, promoter 120 preferably compares AV, the average viewing time as predicted by advertising server 130, with the actual viewing time of the preceding time period. The actual viewing time may differ from the average viewing time due to numerous factors such as client 100 behavior, such as where AV>AC if displayer 160 is visible less often then average, thus limiting the amount of actual viewing time. Promoter 120 preferably updates its requests for advertisements from advertising server 130 based on this comparison. For example, promoter 120 may request N′ advertisements where N′=N*(AC/AV). In this manner, promoter 120 may attempt to insure that each advertisement retrieved from advertising server 130 is viewed once per day on client 100.

Promoter 120 may utilize the specific behavioral patterns of client 100 to better plan the promotion of advertisements. For example, observation may show that, on average, client 100 executes a particular application for one hour each day. Thus, when promoter 120 detects that client 100 has started execution of the application, promoter 120 may request advertisements from advertising server 130 that collectively provide one hour of viewing time.

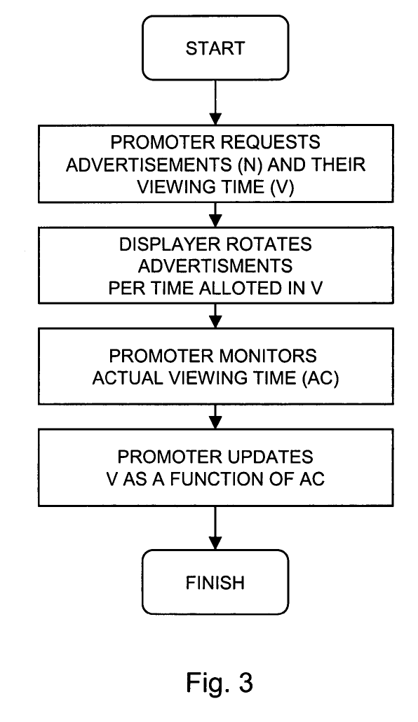

Reference is now made to FIG. 3, which is a simplified flowchart illustration of a method for setting the viewing time of advertisements, operative in accordance with a preferred embodiment of the present invention. The method of FIG. 3 may be implemented by promoter 120 of FIG. 1. In the method of FIG. 3, promoter 120 typically requests from advertising server 130 the maximum amount of advertisements, N, that have been allotted for a particular time period, such as that day, and the desired viewing time per advertisement, Vᵢ. Promoter 120 preferably monitors the behavior of client 100, and in particular the amount of time during which displayer 160 successfully shows advertisements at client 100. Promoter 120 preferably adjusts the time allocated per advertisement, Vᵢ, as a function of the behavior of client 100.

For example, if eight advertisements have been allotted for an eight-hour period within that particular day, i.e. N=8, and an average of sixty seconds of desired viewing time are allocated for each advertisement, i.e. V₁=V₂ . . . =V₈=60, then promoter 120 instructs displayer 160 to show the eights advertisements for an average of sixty seconds of desired viewing time over the course of the eight hour period. The expectation may be that one advertisement will be shown per hour for sixty seconds, as there are eight advertisements to be shown over eight hours. However, since the advertising window controlled by displayer 160 may be active for any part of the eight hour period, it is up to displayer 160 to determine if and when to display an advertisement. Thus, for example, if the advertising window is active for only one minute per hour over the eight hour period, then displayer 160 may indeed show each of the eight advertisements for their desired viewing time of one minute each. If, however, the advertising window is active for more than one minute per hour over the eight hour period, then displayer 160 may show each of the eight advertisements for longer than their desired viewing time of one minute each. Thus, if after two hours of the eight hour period promoter 120 determines that displayer 160 successfully rendered four advertisements for one minute each, since the actual viewing time in the above example was twice the desired viewing time, or four minutes in two hours as opposed to the two minutes as expected, promoter 120 may adjust the remaining values of V for the remain four advertisements not yet rendered by displayer 160 to increase the desired viewing time in proportion to the actual viewing time, such as by setting V₅=V₆ . . . =V₈=120 seconds. Promoter 120 then preferably instructs displayer 160 to show the remaining four advertisements for an average of 120 seconds of desired viewing time over the course of the remaining six hours of the eight hour period.

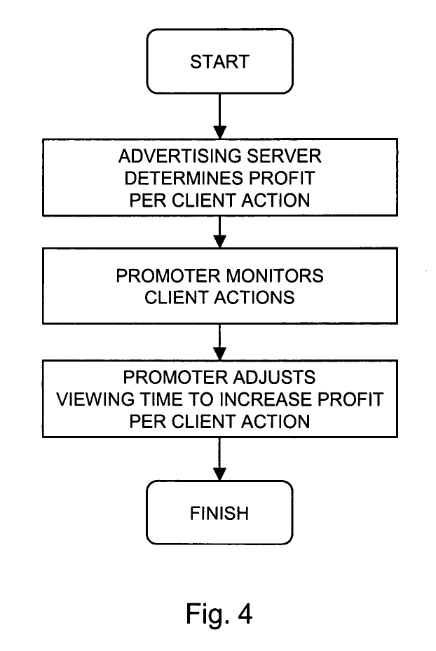

Reference is now made to FIG. 4, which is a simplified flowchart illustration of a method for rotation of advertisements as a function of profit, operative in accordance with a preferred embodiment of the present invention. The method of FIG. 4 may be implemented by promoter 160 of FIG. 1, where the rotation of advertisements is constrained by monetary considerations imposed by advertising server 130 of FIG. 1. In the method of FIG. 4, advertising server 130 preferably maintains in advertising database 140 a set of associations, P, between client 100 behaviors for a specific advertisement, and the expected profit for the promoter from the owner of the advertisement. For example, an advertiser will typically pay more to a promoter for a ‘click through’ than for a ‘view’ of an advertisement. Moreover, some advertisements may have higher values associated with them than others, such as advertisements for expensive merchandise as opposed to inexpensive merchandise. The set P of associations is preferably transmitted to promoter 120, typically along with the time allocated per advertisement, Vᵢ.

In the method of FIG. 4, promoter 120 preferably monitors the behavior of client 100, and promoter 120 may modify the viewing time of one or more advertisements to increase the overall profit based on this behavior. For example, if eight advertisements have been allotted for that particular day, i.e. N=8, and sixty seconds of viewing time are allocated for each advertisement, i.e. V₁=V₂ . . . =V₈=60, and, according to P, the profit for a ‘click through’ on the first four advertisements is twice that of the second four advertisements, i.e. P₁=P₂ . . . =P₄=2 and P₅=P₆ . . . =P₈=1, should promoter 120 detect that users at client 100 click more often on advertisements than a predefined average, then promoter 120 may increase the viewing time of the first four advertisements at the expense of the viewing time of the last four advertisements, such as by setting V₁=V₂ . . . =V₄=90 and V₅=V₆ . . . =V₈=30.

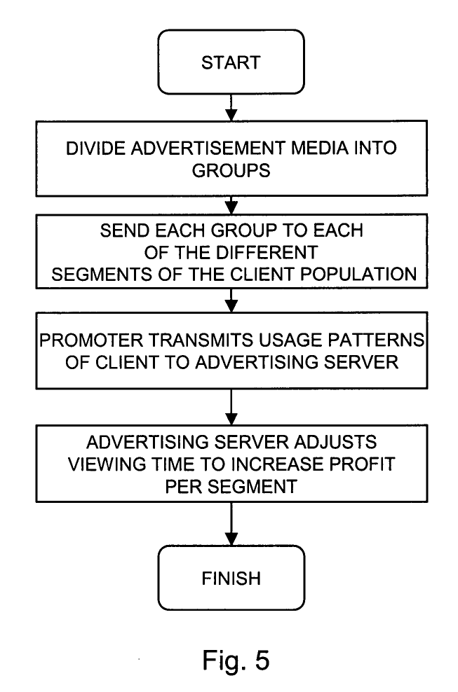

Reference is now made to FIG. 5, which is a simplified flowchart illustration of a method for server-side profit optimization, operative in accordance with a preferred embodiment of the present invention. The method of FIG. 5 may be implemented by advertising server 130 of FIG. 1, where an optimization of advertising parameters, such as a modification of the viewing time of an advertisement to maximize profit, is preferably achieved with a feedback loop, i.e. flow of information back from client 100 to advertising server 130. In the method of FIG. 5, advertising server 130 preferably organizes the available advertisements into groups. Advertising server 130 then distributes each of the groups of advertisements to each of several different population segments. Promoter 120 preferably transmits to advertising server 130 the usage patterns of client 100. Advertising server 130 may then incorporate the client usage statistics into logic used to determine future responses to advertisement requests from promoter 120.

For example, advertising server 130 may randomly assign the available advertisements to one of two groups, where the first group of advertisements contains static advertisements, such as images, and the second group contains dynamic advertisements, such as movies. Advertising server 130 may then divide the client population into two segments, with clients that request news content belonging to the first segment, and clients that request games belonging to the second segment. Advertising server 130 then distributes all the advertisements to each of the segments. Promoter 120 may monitor the client usage patterns, such as the time from display of an advertisement to a mouse click on the advertisement, and transmit the client usage patterns to advertising server 130. Typically, dynamic advertisements are clicked on later than static advertisements, and advertisements shown in conjunction with news content are typically reacted to before advertisements shown in conjunction with games. Advertising server 130 may then determine that a particular client usage pattern is of statistical significance, either by analyzing the client usage pattern of a population segment in isolation or in comparison to other population segments, as is well known in the art. For example, if static advertisements shown in conjunction with news content are clicked on by 90% of the users in the population segment during the first fifteen seconds of display, the probability of a click by a member of the first population segment after the first fifteen seconds is deemed negligible. Alternatively, if 70% of the first population segment, i.e. those receiving news advertisements, click on the static advertisement within the first fifteen seconds and 70% of the second population, i.e. those with games content, do not click on the static advertisement within the first fifteen seconds, the probability of a click by a member of the first population after the first fifteen seconds is deemed negligible. Thereafter, for all clients 100 in the first segment, i.e. the news content segment, that receive advertisements from either one or both groups and are provided by advertising server 130 with a window of time to display the advertisements, as described in greater detail hereinabove with reference to FIGS. 2, 3, and 4, advertising server 130 may modify the viewing time per advertisement, Vᵢ, or may instruct promoter 120 to calculate a modification as described hereinabove with reference to FIG. 3, such as to maximize profitability. For example, advertisements in the first group, i.e. the static advertisements, transmitted to the first population segment, i.e. those that receive news content, may receive less viewing time, such as by limiting the maximum viewing time to fifteen seconds, and subsequently rotating the advertisements more often within the predefined window of time allocated for display of advertisements by client 100. Alternatively, advertisements in the first group, i.e., the static advertisements, may receive less viewing time, such as by limiting the maximum viewing time to fifteen seconds, and subsequently enabling the advertisements in the second group, i.e., the dynamic advertisements, to receive more viewing time within the predefined window of time allocated for display of advertisements by client 100. In this manner, advertising server 100 may increase the probability of a mouse click on an advertisement and the subsequent profitability of the promoter.

It is appreciated that one or more of the steps of any of the methods described herein may be omitted or carried out in a different order than that shown, without departing from the true spirit and scope of the invention.

While the methods and apparatus disclosed herein may or may not have been described with reference to specific computer hardware or software, it is appreciated that the methods and apparatus described herein may be readily implemented in computer hardware or software using conventional techniques.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. An advertising system comprising:
an application for execution by a client;
a promoter;
an advertising server; and
a displayer,
wherein said application is operative to communicate to said promoter information relating to either of the life cycle and the current status of either of said application and said client,
wherein said promoter is operative to communicate a request for instructions to said advertising server,
wherein said advertising server is operative to construct and transmit to said promoter a set of instructions for said promoter indicating at least one advertisement of relevance to said client based on a predefined relevance measure of said information, and
wherein said promoter is operative to retrieve said advertisement indicated in said instructions and provide said advertisement for rendering by said displayer at said client.

2. A system according to claim 1 wherein said request includes any of said information.

3. A system according to claim 1 and further comprising an advertising database operative to store meta-information related to said advertisement.

4. A system according to claim 3 wherein said meta-information includes a categorization of said advertisement.

5. A system according to claim 1 wherein said indication of said advertisement includes a link to said advertisement on a creative server.

6. A system according to claim 1 wherein said displayer is operative to activate a window on said client in which said advertisement may be viewed.

7. A system according to claim 1 wherein said displayer is operative to activate said window when said application is active on said client, and either hide or deactivate said window when said application is no longer active on said client.

8. A system according to claim 1 wherein said displayer is operative to notify said promoter upon the successful rendering of said advertisement.

9. A system according to claim 1 wherein said displayer is operative to notify said promoter of any user interaction with said advertisement.

10. A system according to claim 1 wherein said promoter is operative to provide display statistics for said advertisement to said advertising server.

11. A method for rotation of advertisements, the method comprising:
assembling a first plurality of advertisements;
instructing a displayer to rotatingly display said first plurality of advertisements;
recording an actual viewing time for said first plurality of advertisements;
comparing said actual viewing time with a predicted viewing time of said first plurality of advertisements;
assembling a second plurality of advertisements as a function of said comparison.

12. A method for managing advertisements, the method comprising:
detecting a usage pattern of a client; and
assembling a plurality of advertisements for display at said client as a function of said usage pattern.

13. A method for managing advertisements, the method comprising:
monitoring the display of a plurality of advertisements at a client;
comparing the actual viewing time of said plurality of advertisements with an expected viewing time of said plurality of advertisements; and
adjusting the desired viewing time of any of said plurality of advertisements as a predetermined function of said comparison.

14. A method for managing advertisements as a function of profit, the method comprising:
maintaining an association between client behavior regarding an advertisement and an expected profit for a promoter from an owner of said advertisement;
monitoring the behavior of a client; and
modifying the allotted viewing time of an advertisement at said client in accordance with a predefined function of said behavior in order to maximize said expected profit.

15. A method for server-side profit optimization, the method comprising:
organizing a plurality of advertisements into at least two groups;
distributing each of said groups of advertisements to each of a plurality of different population segments;
monitoring a client usage pattern with respect to any of said advertisements in any of said groups; and
providing advertisements from any two of said groups to a client together with a total display time adapted in accordance with a predefined function of said client usage pattern.

16. A method according to claim 15 and further comprising reducing said display time of any of said advertisements provided to said client and belonging to one of said groups, and increasing the display time of any others of said advertisements provided to said client and belonging to another of said groups, wherein said increasing and reducing steps are performed as a function of said client usage pattern indicating a lower likelihood of client interaction with advertisements in said reduced display time group and a greater likelihood of client interaction with advertisements in said increased display time group and wherein said total display time is preserved.
